(19) United States
(12) Patent Application Publication
(10) Pub. No.: US 2015/0100223 A1
(43) Pub. Date: Apr. 9, 2015

(54) Operator Free System For Self-Propelled Small Cars For Children

(71) Applicant: EUROGAMES S.R.L., Forli (FC) (IT)

(72) Inventor: Pier Sante ZACCHERONI, Forli (IT)

(21) Appl. No.: 14/504,692

(22) Filed: Oct. 2, 2014

(30) Foreign Application Priority Data
Oct. 3, 2013 (IT) BO2013A 000546

(51) Int. Cl. G08G 1/123; G05D 1/02

(52) U.S. Cl. CPC G08G 1/123; G05D 1/0291
USPC 701/117

(57) ABSTRACT

An operator free system permitting use by children of self-propelled vehicles has a track delimited by a fence. An input door device allows access into the track by only one child a time, an access detector signaling each child's entry. One exit door device allows exit from the track, an exit detector signaling at each child's exit. Each vehicle is equipped with a traction motor, a seat provided with a presence sensor, and a safety belt detector. A management and control unit receives signals from the access detector, exit detector, presence sensor, and seat belt detector, being configured to remotely control each traction motor. The management and control unit determines on the basis of the received signals, a number of children within the fence and will activate the traction motors only if the number of occupied vehicles, with seatbelts fastened, corresponds to a number of children within the fence.

### CROSS REFERENCE TO RELATED APPLICATIONS

This application claims priority in Italian Patent application no. BO2013A 000546 filed on Oct. 3, 2013, the contents of which are incorporated by reference.

### TECHNICAL FIELD

The present invention concerns play systems and refers to an operator free system for permitting operation of self-propelled small cars by children.

### BACKGROUND

Driving tracks are known for use by small cars which allow children to drive cars, generally electrically propelled, upon payment of a fee.

On such tracks, the operators must ensure system safety and effectiveness, in particular to ensure that no child is exposed to hazardous conditions, for example, from walking on a track occupied by cars in motion.

One disadvantage of such car systems is that they require the presence and constant attention of at least one operator, generally two or more, responsible for various operational and safety functions.

Another disadvantage is that it is not always possible to ensure complete child safety.

### SUMMARY OF THE INVENTION

One object of the present invention is to propose an operator free system for self-propelled cars for use by children capable of ensuring effectiveness and safety, even without an operator's constant presence.

Another object is to propose a system fit for driving by children, which provides instructions and guidance for children accessing the small cars.

### BRIEF DESCRIPTION OF THE DRAWINGS

The characteristics of the invention are below highlighted with particular reference to the accompanying drawings in which:

FIG. 1 shows a plan and schematic view of the operator free system for self-propelled small cars for children which is the object of the present invention.

### DETAILED DESCRIPTION OF THE INVENTION

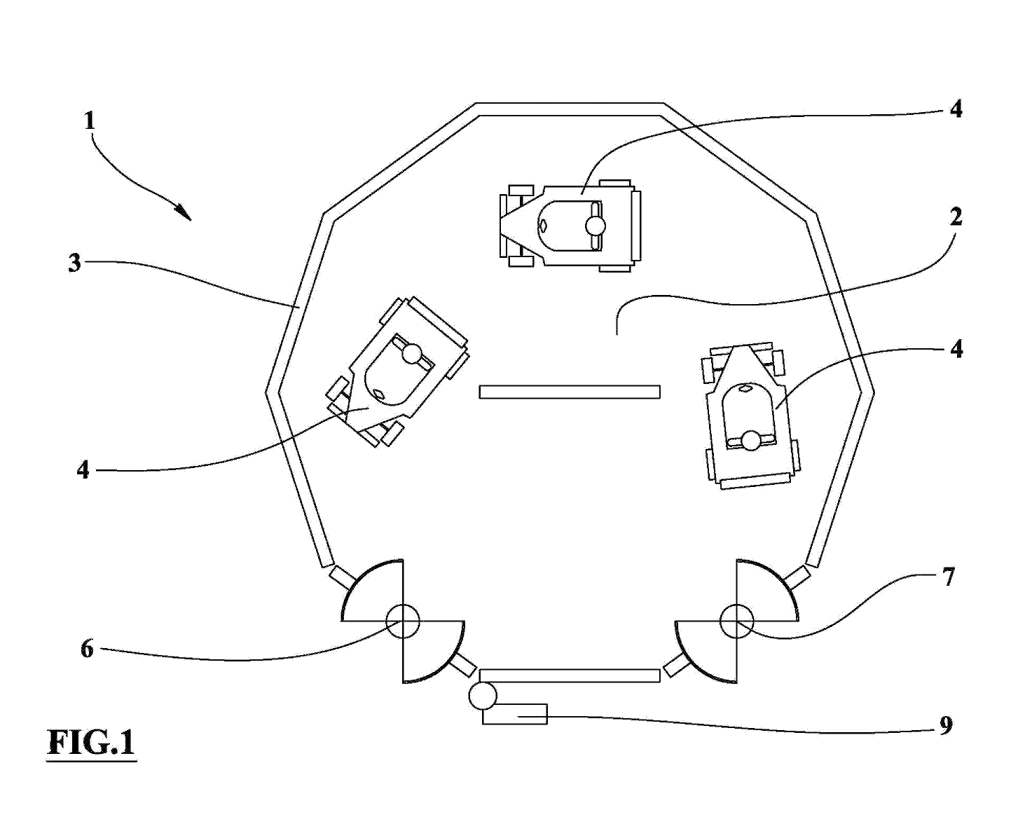

With reference to FIG. 1, numeral 1 refers to an operator free system for self-propelled small cars for use by children comprising a track 2, consisting of an area or a path, delimited by a fence 3 adapted to be locked and to prevent the exit of cars 4.

In the context of the present invention, the term “small car” is of very wide meaning and comprises any vehicle suitable for children such as those in the form of small cars, wheeled animals, small trains, small motorcycles, three-wheeled vehicles and in general any ridable vehicle or into which it is possible for a child to enter.

The system comprises an input door device 6, for example a turnstile, associated with an opening in the fence 3 and adapted to allow access onto the track 2 to only one child at a time. The turnstile is provided with an access detector, for example an electromechanical device, having a motion sensor, a volumetric or infrared sensor or a similar device, also being capable of emitting a signal with each child's admission.

The system 1 also includes an output door device 7, for example of the same type as the input door device, associated with a passage through the fence 3 and adapted to allow exit from the track 3 of only one child at a time. The output door device is also provided with an exit detector, for example of the same type as used with the input device, capable of emitting a signal as each child exits from the track.

The system is equipped with a plurality of small cars 4, each equipped with a traction motor, for example of an electric type, which can be remotely switched on and off, and with a seat provided with a sensor configured to emit a presence signal when a child's sits thereon. Also provided is a safety belt with a detector for detecting the connection state and configured to emit a respective signal as to whether the safety belt is connected or unconnected.

The system is equipped with a management and control unit 9 located outside of the track fence, preferably being of the digital programmable microprocessor type, in data connection with the access detector, the exit detector, the presence sensor, the seat belt connection state detector and able to individually switch on and off each remote traction motor.

The management and control unit 9 is provided with programs configured to determine, when in an operative condition and on the basis of received signals, the number of children within the fence 3 and to activate a traction motor only and exclusively if the number of cars that are occupied and with belts fastened corresponds to the number of children present inside the track.

The system further comprises devices for accepting payment, of the type accepting tokens, coins, cards or other items, the payment device associated or connected to the management and control unit 9. The input door device 6 is adapted to be locked and the unit 9 is configured to unlock this for the passage of a child only in event that payment is received and if the unit determines that at least one small car is free and available and that the track is safe to enter.

The management and control unit 9 and/or payment devices are provided with at least one indicator, which can be flashing lights, intermittent lights or fixed lights, a graphic screen, or speakers, to provide messages and graphic or vocal instructions to bystanders or to children and theft companions.

The input device 6 and exit device 7 are equipped with green and/or red signal lights indicating the conditions of opening or closing of the input and exit door devices at the end of the period of a game.

Each small car 4 is provided with a plurality of light sources, such as LED's, arranged to the sides of the seat and/or the sides of the small car and remotely controlled by the management and control unit 9 and/or locally by an ignition switch of the same small car to indicate the available or unavailable status of the small car.

Each small car 4 is provided with loudspeakers controlled by the management and control unit 9 and/or by ignition switch of the same small car to provide instructions and messages to children, such as an invitation to get on, instructions for belt dosing and warning of the beginning of the game.

The system, for greater security, may possibly include a counting or verification device as to the number of cars on the track, connected to the management and control unit 9.

The system comprises an alarm actuated by the management and control unit 9 in case of anomalies for calling an operator and optionally comprises, for each small car, a parking station equipped at least with a recharging connection and/or routing guides configured to guide the return of each small car, as it is approaching the parking station and directing the small car using respective automatic parking station signals.

It is also expected that the system can be provided with an optional video recorder, with a visual field including the track, and connected to a recording and/or digital graphics processor be to verify the normal operation of the game, optionally adapted for communication with the management and control unit 9.

The system effectively controls preliminarily the present car number and the access number to prevent the number of children from exceeding the number of cars present on the track and available.

The input and exit door lights are normally red colored while those of the control system are switched off.

After inserting a token, coins or other payment forms into the access control system, an activation token is returned recognized by a token machine or similar device, by the cars and then the revolving input door (green light) is activated. A voice asks the child to enter.

The child enters, the system counts him and the door light turns red again.

On an unoccupied and available car, the flashing lights, placed around the seat (or elsewhere), lights up and a voice message invites the child to sit on the seat.

When the child sits, a voice message (issued from the car) invites the child to fasten his seat belt. The child is also invited to insert the activation token. The car operation is subject to the presence of the token. If after a certain time the token is not inserted, the control system actuates the signal to invoke the operator's intervention.

When another child enters, the invitation is repeated.

When there are no more available cars, the control system warns any waiting children and prevents a further entry.

When all entering children have fastened their seat belts, the control system waits ten seconds (timeout for any other entry) while generating a message, for example: “ready, soon we start”.

After the timeout the game begins and the children can drive their cars.

When the game time has expired, the small cars stop and the exit door light turns green. The management and control unit, through flashing and a voice, invites the children to exit the cars and the track.

The control system calculates the number of children that have exited and makes sure that the track is empty before accepting the subsequent entries.

If this does not occur within a certain time, the control system turns on a flashing red light and emits a warning voice to invoke the attention of an operator.

The access door device is locked until the operator turns off the alarm or the last child has exited the track.

The exit door is always free to turn for allowing the exit of anyone inside of the track who wants to exit at any time.

The revolving doors must be configured so as not to allow the incorrect counting of exiting children, for example, the counting output should not be altered if the exit door is rotated by hand.

The revolving doors are built so as to avoid a possible collision by one of the cars in the game.

If a child inserts a coin and comes in and out without using the car, the control system could take this into account and make available the car released.

After a timeout period, if the children who entered are not all seated with their seat belts fastened, the control system must go into alarm.

The control system manages all the “abnormal” conditions that may happen, for example, the detachment of a seat belt and the exit of a child during the game. In these cases, all the small cars are stopped to ensure the child's safety.

An object of the present invention is to provide a system operable automatically without an operator permitting operation of self-propelled small cars by children, the system capable of ensuring safe operation, even without the constant presence of an operator.

Another advantage is to provide a system able to guide and give instructions to the children for the access to the cars and to prepare for the game.

1. An operator free system for permitting use by children of self-propelled small vehicles comprising:
a track, consisting of an area or in a path, delimited by a fence configured to be locked and to prevent exit of the vehicles
at least one input door device associated with an entrance opening in the fence and configured to allow only to one child a time to gain access onto the track and having an access detector adapted to emit a signal corresponding to each entry by a child;
at least one exit door device associated with an exit opening in the fence and configured to allow only one child at a time to exit from the track and having an exit detector adapted to emit a signal corresponding to each exit by a child from the track;
a plurality of small vehicles, each equipped with at least one traction motor remotely switchable on and off, and each having a seat provided with a presence sensor adapted to emit a child presence signal, and each having a safety belt with a detector for detecting a connection state of the seat belt, and adapted to emit a signal on the connection state;
a management and control unit in data connection with the access detector, the exit detector, the presence sensors, the connection state detectors and being capable of switching on and off each individual remote traction motor;
the management and control unit configured to determine, when in an operating condition and on the basis of the received signals, the number of children within the fence and to activate individual traction motors only if the number of cars that are occupied and with their seat belts fastened corresponds to the number of children within the fence.

2. The system according to claim 1 further comprising a payment device adapted for taking payment, and being connected to the management and control unit, the input door device being locked by said unit, and unlocked only when payment is received.

3. The system according to claim 2 wherein the management and control unit and/or payment device have at least one indicator selected from the group consisting of flashing lights, intermittent lights, fixed lights, a graphic screen, an LCD display, audio speakers and combinations thereof, to provide visual or vocal messages and instructions.

4. The system according to claim 1 wherein at least one of the input door device and the exit door device is equipped with green and/or red signal lights to indicate an opening or closing condition of the respective door device.

5. The system according to claim 1 wherein each small vehicle has a plurality of light sources arranged along side of each seat and/or on sides of the vehicle and controlled by the management and control unit and/or by an ignition switch of the respective vehicle to indicate whether the small vehicle is available or unavailable for use by a child.

6. The system according to claim 1 wherein each small vehicle has an audio speaker controlled by the management and control unit and/or by an ignition switch of the respective small vehicle for providing audio instructions and messages to a child using the respective small vehicle.

7. The system according to claim 1 further comprising a counting or verification device configured to determine a number of small vehicles present on the track, and optionally adapted for communication with the management and control unit (9).

8. The system according to claim 1 further comprising an alarm, actuated by the management and control unit upon detecting an anomaly, the alarm signalling for attention by an operator.

9. The system according to claim 1 further comprising a parking station for each small vehicle, equipped with at least one recharging connection and/or routing guides adapted to guide a return of each small vehicle to the parking station, to guide an approach and for receiving automatic parking station signals.

10. The system according to claim 1 further comprising a video recorder with a visual field covering the track and connected to a recorder and/or a digital graphics processor, and adapted for communication with the management and control unit.
